(19) United States
(12) Patent Application Publication
(10) Pub. No.: US 2012/0192841 A1
(43) Pub. Date: Aug. 2, 2012

(54) SPLIT-CYCLE AIR HYBRID ENGINE WITH DWELL CAM

(75) Inventors: Riccardo Meldolesi, West Sussex (GB); John Schwoerer, Storrs, CT (US); Nicholas Badain, West Sussex (GB); Clive Lacy, West Sussex (GB)

(73) Assignee: SCUDERI GROUP, LLC, West Springfield, MA (US)

(21) Appl. No.: 13/359,525

(22) Filed: Jan. 27, 2012

Related U.S. Application Data
(60) Provisional application No. 61/436,742, filed on Jan. 27, 2011.

(51) Int. Cl. F02B 33/22

(52) U.S. Cl. 123/70 R; 123/65 R

(57) ABSTRACT

Devices and related methods are disclosed that generally involve actuating an engine valve with a cam having a dwell section. These devices and methods have application in split-cycle engines, air hybrid engines, conventional engines, and/or various combinations thereof. Both inwardly- and outwardly-opening valves can be actuated with the devices and methods disclosed herein. Additional valve train elements are disclosed, including rockers, lost-motion systems, and valve seating control devices.

### CROSS-REFERENCE TO RELATED APPLICATIONS

This application claims the benefit of priority of U.S. Provisional Patent Application No. 61/436,742, filed on Jan. 27, 2011, the entire contents of which are incorporated herein by reference.

### FIELD

The present invention relates to valve actuation systems. More particularly, the invention relates to split-cycle air hybrid engines with one or more dwell cams.

### BACKGROUND

Internal combustion engines generally include one or more valves for controlling the flow of air and fuel through the engine. These valves are usually actuated by a mechanical cam. For example, a rotating shaft having a teardrop-shaped cam lobe is configured to impart motion to the valve, either directly or via one or more intermediate elements. As the shaft rotates, the eccentric portion of the cam lobe imparts a linear motion to the valve over a range of the shaft's rotation. Cam lobes are typically shaped such that the eccentric portion consists of an opening ramp and a closing ramp.

It is desirable to alter the rate, timing, and duration of valve opening and closing to achieve optimum engine efficiency for a variety of operating speeds, loads, temperatures, etc. In addition, in an air hybrid engine in which momentum energy of a vehicle is recycled using air as the storage medium, certain hybrid operating modes require that one or more of the engine valves stay open longer than in other operating modes, and longer than in a non-hybrid, traditional combustion operating mode. Methods and devices for varying the opening and closing parameters of the valve are therefore required.

“Lost-motion” systems have been developed to permit a valve to close earlier than what is called for by the cam. Lost-motion systems generally include a lost-motion valve train element that can be selectively actuated to operatively disconnect a cam from a valve during a portion of the cam's rotation. The motion that would have otherwise been imparted to the valve (had the valve not been operatively disconnected) is thus lost.

To operate an engine, and in particular an air hybrid engine, efficiently across a plurality of operating ranges, it is desirable to have a wide range of valve opening and closing dynamics (e.g., opening rate, opening timing, duration, closing rate, closing timing, etc.). To accomplish such a wide range with a cam and lost-motion system, the duration of the cam must generally be as long as the longest opening duration that will be required. (Lost-motion systems can typically close the valve earlier than what the cam calls for, but cannot generally hold the valve open longer than what the cam calls for, at least not efficiently).

To accomplish such long durations with a traditional cam lobe shape (i.e., wherein the eccentric portion, or lobe, of the cam has a single peak at substantially a single point (e.g., less than 1 crank angle degree) on its contour), while maintaining the opening and closing rates required for normal engine operation, higher lifts than are necessary for engine breathing are required. If the valve lift is too high, however, valve interference issues occur. Also, lifting an engine valve more than ⅓ of the valve head's diameter provides only marginal improvement in air flow around the valve. Accordingly, the energy used to lift the valve beyond that point (i.e., the energy exerted compressing the valve spring) is largely wasted, especially if the valve train is of the lost motion type, where the potential energy stored in the valve spring when opening the valve cannot be recovered, thereby reducing the overall efficiency of the engine.

Accordingly, there is a need for improved valve actuation systems that can achieve the durations required for efficient operation of an internal combustion engine and in particular of a split-cycle air hybrid internal combustion engine, without the parasitic losses associated with high lift cams.

For purposes of clarity, the term “conventional engine” as used in the present application refers to an internal combustion engine wherein all four strokes of the well-known Otto cycle (the intake, compression, expansion and exhaust strokes) are contained in each piston/cylinder combination of the engine. Each stroke requires one half revolution of the crankshaft (180 degrees crank angle (“CA”)), and two full revolutions of the crankshaft (720 degrees CA) are required to complete the entire Otto cycle in each cylinder of a conventional engine.

Also, for purposes of clarity, the following definition is offered for the term “split-cycle engine” as may be applied to engines disclosed in the prior art and as referred to in the present application.

A split-cycle engine generally comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft; and

a crossover passage interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween.

A split-cycle air hybrid engine combines a split-cycle engine with an air reservoir and various controls. This combination enables the engine to store energy in the form of compressed air in the air reservoir. The compressed air in the air reservoir is later used in the expansion cylinder to power the crankshaft. In general, a split-cycle air hybrid engine as referred to herein comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft;

a crossover passage (port) interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween; and

an air reservoir operatively connected to the crossover passage and selectively operable to store compressed air from the compression cylinder and to deliver compressed air to the expansion cylinder.

FIG. 1 illustrates one exemplary embodiment of a prior art split-cycle air hybrid engine. The split-cycle engine 100 replaces two adjacent cylinders of a conventional engine with a combination of one compression cylinder 102 and one expansion cylinder 104. The compression cylinder 102 and the expansion cylinder 104 are formed in an engine block in which a crankshaft 106 is rotatably mounted. Upper ends of the cylinders 102, 104 are closed by a cylinder head 130. The crankshaft 106 includes axially displaced and angularly offset first and second crank throws 126, 128, having a phase angle therebetween. The first crank throw 126 is pivotally joined by a first connecting rod 138 to a compression piston 110 and the second crank throw 128 is pivotally joined by a second connecting rod 140 to an expansion piston 120 to reciprocate the pistons 110, 120 in their respective cylinders 102, 104 in a timed relation determined by the angular offset of the crank throws and the geometric relationships of the cylinders, crank, and pistons. Alternative mechanisms for relating the motion and timing of the pistons can be utilized if desired. The rotational direction of the crankshaft and the relative motions of the pistons near their bottom dead center (BDC) positions are indicated by the arrows associated in the drawings with their corresponding components.

The four strokes of the Otto cycle are thus “split” over the two cylinders 102 and 104 such that the compression cylinder 102 contains the intake and compression strokes and the expansion cylinder 104 contains the expansion and exhaust strokes. The Otto cycle is therefore completed in these two cylinders 102, 104 once per crankshaft 106 revolution (360 degrees CA).

During the intake stroke, intake air is drawn into the compression cylinder 102 through an inwardly-opening (opening inward into the cylinder and toward the piston) poppet intake valve 108. During the compression stroke, a compression piston 110 pressurizes the air charge and drives the air charge through a crossover passage 112, which acts as the intake passage for the expansion cylinder 104. The engine 100 can have one or more crossover passages 112.

The volumetric (or geometric) compression ratio of the compression cylinder 102 of the split-cycle engine 100 (and for split-cycle engines in general) is herein referred to as the “compression ratio” of the split-cycle engine. The volumetric (or geometric) compression ratio of the expansion cylinder 104 of the engine 100 (and for split-cycle engines in general) is herein referred to as the “expansion ratio” of the split-cycle engine. The volumetric compression ratio of a cylinder is well known in the art as the ratio of the enclosed (or trapped) volume in the cylinder (including all recesses) when a piston reciprocating therein is at its bottom dead center (BDC) position to the enclosed volume (i.e., clearance volume) in the cylinder when said piston is at its top dead center (TDC) position. Specifically for split-cycle engines as defined herein, the compression ratio of a compression cylinder is determined when the XovrC valve is closed. Also specifically for split-cycle engines as defined herein, the expansion ratio of an expansion cylinder is determined when the XovrE valve is closed.

Due to very high volumetric compression ratios (e.g., 20 to 1, 30 to 1, 40 to 1, or greater) within the compression cylinder 102, an outwardly-opening (opening outwardly away from the cylinder and piston) poppet crossover compression (XovrC) valve 114 at the crossover passage inlet is used to control flow from the compression cylinder 102 into the crossover passage 112. Due to very high volumetric compression ratios (e.g., 20 to 1, 30 to 1, 40 to 1, or greater) within the expansion cylinder 104, an outwardly-opening poppet crossover expansion (XovrE) valve 116 at the outlet of the crossover passage 112 controls flow from the crossover passage 112 into the expansion cylinder 104. The actuation rates and phasing of the XovrC and XovrE valves 114, 116 are timed to maintain pressure in the crossover passage 112 at a high minimum pressure (typically 20 bar or higher at full load) during all four strokes of the Otto cycle.

At least one fuel injector 118 injects fuel into the pressurized air at the exit end of the crossover passage 112 in coordination with the XovrE valve 116 opening. Alternatively, or in addition, fuel can be injected directly into the expansion cylinder 104. The fuel-air charge fully enters the expansion cylinder 104 shortly after the expansion piston 120 reaches its top dead center (“TDC”) position. As the piston 120 begins its descent from its TDC position, and while the XovrE valve 116 is still open, one or more spark plugs 122 are fired to initiate combustion (typically between 10 to 20 degrees CA after TDC of the expansion piston 120). Combustion can be initiated while the expansion piston is between 1 and 30 degrees CA past its TDC position. More preferably, combustion can be initiated while the expansion piston is between 5 and 25 degrees CA past its TDC position. Most preferably, combustion can be initiated while the expansion piston is between 10 and 20 degrees CA past its TDC position. Additionally, combustion can be initiated through other ignition devices and/or methods, such as with glow plugs, microwave ignition devices, or through compression ignition methods.

The XovrE valve 116 is then closed before the resulting combustion event enters the crossover passage 112. The combustion event drives the expansion piston 120 downward in a power stroke. Exhaust gases are pumped out of the expansion cylinder 104 through an inwardly-opening poppet exhaust valve 124 during the exhaust stroke.

With the split-cycle engine concept, the geometric engine parameters (i.e., bore, stroke, connecting rod length, compression ratio, etc.) of the compression and expansion cylinders are generally independent from one another. For example, the crank throws 126, 128 for the compression cylinder 102 and expansion cylinder 104, respectively, have different radii and are phased apart from one another with TDC of the expansion piston 120 occurring prior to TDC of the compression piston 110. This independence enables the split-cycle engine to potentially achieve higher efficiency levels and greater torques than typical four-stroke engines.

The geometric independence of engine parameters in the split-cycle engine 100 is also one of the main reasons why pressure can be maintained in the crossover passage 112 as discussed earlier. Specifically, the expansion piston 120 reaches its top dead center position prior to the compression piston 110 reaching its top dead center position by a discrete phase angle (typically between 10 and 30 crank angle degrees). This phase angle, together with proper timing of the XovrC valve 114 and the XovrE valve 116, enables the split-cycle engine 100 to maintain pressure in the crossover passage 112 at a high minimum pressure (typically 20 bar absolute or higher during full load operation) during all four strokes of its pressure/volume cycle. That is, the split-cycle engine 100 is operable to time the XovrC valve 114 and the XovrE valve 116 such that the XovrC and XovrE valves 114, 116 are both open for a substantial period of time (or period of crankshaft rotation) during which the expansion piston 120 descends from its TDC position towards its BDC position and the compression piston 110 simultaneously ascends from its BDC position towards its TDC position. During the period of time (or crankshaft rotation) that the crossover valves 114, 116 are both open, a substantially equal mass of gas is transferred (1) from the compression cylinder 102 into the crossover passage 112 and (2) from the crossover passage 112 to the expansion cylinder 104. Accordingly, during this period, the pressure in the crossover passage is prevented from dropping below a predetermined minimum pressure (typically 20, 30, or 40 bar absolute during full load operation). Moreover, during a substantial portion of the intake and exhaust strokes (typically 90% of the entire intake and exhaust strokes or greater), the XovrC valve 114 and XovrE valve 116 are both closed to maintain the mass of trapped gas in the crossover passage 112 at a substantially constant level. As a result, the pressure in the crossover passage 112 is maintained at a predetermined minimum pressure during all four strokes of the engine's pressure/volume cycle.

For purposes herein, the method of opening the XovrC 114 and XovrE 116 valves while the expansion piston 120 is descending from TDC and the compression piston 110 is ascending toward TDC in order to simultaneously transfer a substantially equal mass of gas into and out of the crossover passage 112 is referred to herein as the “push-pull” method of gas transfer. It is the push-pull method that enables the pressure in the crossover passage 112 of the engine 100 to be maintained at typically 20 bar or higher during all four strokes of the engine's cycle when the engine is operating at full load.

The crossover valves 114, 116 are actuated by a valve train that includes one or more cams (not shown). In general, a cam-driven mechanism includes a camshaft mechanically linked to the crankshaft. One or more cams are mounted to the camshaft, each having a contoured surface that controls the valve lift profile of the valve event (i.e., the event that occurs during a valve actuation). The XovrC valve 114 and the XovrE valve 116 each can have its own respective cam and/or its own respective camshaft. As the XovrC and XovrE cams rotate, eccentric portions thereof impart motion to a rocker arm, which in turn imparts motion to the valve, thereby lifting (opening) the valve off of its valve seat. As the cam continues to rotate, the eccentric portion passes the rocker arm and the valve is allowed to close.

For purposes herein, a valve event (or valve opening event) is defined as the valve lift from its initial opening off of its valve seat to its closing back onto its valve seat versus rotation of the crankshaft during which the valve lift occurs. Also, for purposes herein, the valve event rate (i.e., the valve actuation rate) is the duration in time required for the valve event to occur within a given engine cycle. It is important to note that a valve event is generally only a fraction of the total duration of an engine operating cycle (e.g., 720 degrees CA for a conventional engine cycle and 360 degrees CA for a split-cycle engine).

The split-cycle air hybrid engine 100 also includes an air reservoir (tank) 142, which is operatively connected to the crossover passage 112 by an air reservoir tank valve 152. Embodiments with two or more crossover passages 112 may include a tank valve 152 for each crossover passage 112, which connect to a common air reservoir 142, or alternatively each crossover passage 112 may operatively connect to separate air reservoirs 142.

The tank valve 152 is typically disposed in an air tank port 154, which extends from the crossover passage 112 to the air tank 142. The air tank port 154 is divided into a first air tank port section 156 and a second air tank port section 158. The first air tank port section 156 connects the air tank valve 152 to the crossover passage 112, and the second air tank port section 158 connects the air tank valve 152 to the air tank 142. The volume of the first air tank port section 156 includes the volume of all additional recesses which connect the tank valve 152 to the crossover passage 112 when the tank valve 152 is closed. Preferably, the volume of the first air tank port section 156 is small relative to the second air tank port section 158. More preferably, the first air tank port section 156 is substantially non-existent, that is, the tank valve 152 is most preferably disposed such that it is flush against the outer wall of the crossover passage 112.

The tank valve 152 may be any suitable valve device or system. For example, the tank valve 152 may be a pressure activated check valve, or an active valve which is activated by various valve actuation devices (e.g., pneumatic, hydraulic, cam, electric, or the like). Additionally, the tank valve 152 may comprise a tank valve system with two or more valves actuated with two or more actuation devices.

The air tank 142 is utilized to store energy in the form of compressed air and to later use that compressed air to power the crankshaft 106. This mechanical means for storing potential energy provides numerous potential advantages over the current state of the art. For instance, the split-cycle air hybrid engine 100 can potentially provide many advantages in fuel efficiency gains and NOx emissions reduction at relatively low manufacturing and waste disposal costs in relation to other technologies on the market, such as diesel engines and electric-hybrid systems.

The engine 100 typically runs in a normal operating or firing (NF) mode (also commonly called the engine firing (EF) mode) and one or more of four basic air hybrid modes. In the EF mode, the engine 100 functions normally as previously described in detail herein, operating without the use of the air tank 142. In the EF mode, the air tank valve 152 remains closed to isolate the air tank 142 from the basic split-cycle engine. In the four air hybrid modes, the engine 100 operates with the use of the air tank 142.

The four basic air hybrid modes include:

1) Air Expander (AE) mode, which includes using compressed air energy from the air tank 142 without combustion;

2) Air Compressor (AC) mode, which includes storing compressed air energy into the air tank 142 without combustion;

3) Air Expander and Firing (AEF) mode, which includes using compressed air energy from the air tank 142 with combustion; and

4) Firing and Charging (FC) mode, which includes storing compressed air energy into the air tank 142 with combustion.

Further details on split-cycle engines can be found in U.S. Pat. No. 6,543,225 entitled Split Four Stroke Cycle Internal Combustion Engine and issued on Apr. 8, 2003; and U.S. Pat. No. 6,952,923 entitled Split-Cycle Four-Stroke Engine and issued on Oct. 11, 2005, each of which is incorporated by reference herein in its entirety.

Further details on air hybrid engines are disclosed in U.S. Pat. No. 7,353,786 entitled Split-Cycle Air Hybrid Engine and issued on Apr. 8, 2008; U.S. Patent Application No. 61/365,343 entitled Split-Cycle Air Hybrid Engine and filed on Jul. 18, 2010; and U.S. Patent Application No. 61/313,831 entitled Split-Cycle Air Hybrid Engine and filed on Mar. 15, 2010, each of which is incorporated by reference herein in its entirety.

### SUMMARY

The devices and methods disclosed herein generally involve actuating an engine valve with a cam having a dwell section. These devices and methods have application in split-cycle engines, air hybrid engines, conventional engines, and/or various combinations thereof.

In one aspect of at least one embodiment of the invention, an engine is provided that includes an air reservoir for storing compressed air during a plurality of cycles of the engine and at least one cam having a dwell section of at least approximately 5 degrees CA.

In another aspect of at least one embodiment of the invention, an engine is provided that includes an air reservoir configured to selectively store air from a cylinder in which the air was compressed in a compression stroke of the engine and to selectively supply air to a cylinder during an expansion stroke of the engine. The engine further includes at least one engine valve configured to open and close a passageway disposed within the engine and a camshaft having at least one cam formed thereon, the at least one cam having a dwell section of at least 5 degrees CA and being configured to impart motion to the at least one engine valve.

In another aspect of at least one embodiment of the invention, an air hybrid engine is provided that includes a cam having a base circle portion, an opening ramp portion, a closing ramp portion, and a dwell section extending between the opening ramp portion and the closing ramp portion. The dwell section extends across at least 5 degrees CA of the cam's profile.

In another aspect of at least one embodiment of the invention, an air hybrid engine is provided that includes a camshaft having at least one cam lobe, wherein the cam lobe has a dwell section of at least 5 degrees CA.

In another aspect of at least one embodiment of the invention, an engine is provided that includes a crankshaft rotatable about a crankshaft axis, a compression piston slidably received within a compression cylinder and operatively connected to the crankshaft such that the compression piston reciprocates through an intake stroke and a compression stroke during a single rotation of the crankshaft, and an expansion piston slidably received within an expansion cylinder and operatively connected to the crankshaft such that the expansion piston reciprocates through an expansion stroke and an exhaust stroke during a single rotation of the crankshaft. The engine also includes a crossover passage interconnecting the compression and expansion cylinders, the crossover passage including a crossover compression valve and a crossover expansion valve defining a pressure chamber therebetween. The engine also includes a first cam configured to impart motion to the crossover expansion valve, the first cam having a dwell section of at least 5 degrees CA, and a first collapsible lost-motion element having a first position in which the crossover compression valve is operatively disconnected from the first cam and a second position in which the crossover compression valve is operatively connected to the first cam.

In another aspect of at least one embodiment of the invention, a method of actuating an engine valve is provided that includes holding the engine valve open in a dwell position over at least 5 degrees of crankshaft rotation.

In another aspect of at least one embodiment of the invention, a method of actuating an engine valve is provided that includes opening the engine valve by imparting motion thereto with an opening ramp profile of a cam having a dwell section of at least 5 degrees CA. The method also includes holding the engine valve in a fully opened position for a first time period and closing the engine valve by actuating a lost-motion system to operatively disconnect the engine valve from the cam.

In another aspect of at least one embodiment of the engine, a split-cycle air-hybrid engine is provided that includes a crankshaft rotatable about a crankshaft axis, a compression piston slidably received within a compression cylinder and operatively connected to the crankshaft such that the compression piston reciprocates through an intake stroke and a compression stroke during a single rotation of the crankshaft, and an expansion piston slidably received within an expansion cylinder and operatively connected to the crankshaft such that the expansion piston reciprocates through an expansion stroke and an exhaust stroke during a single rotation of the crankshaft. The engine also includes a crossover passage interconnecting the compression and expansion cylinders, the crossover passage including a crossover compression (XovrC) valve and a crossover expansion (XovrE) valve defining a pressure chamber therebetween. The engine also includes an air reservoir operatively connected to the crossover passage and selectively operable to store compressed air from the compression cylinder and to deliver compressed air to the expansion cylinder. The engine also includes a first cam configured to impart motion to at least one of the XovrC valve and the XovrE valve, the first cam having a dwell section of at least 5 degrees CA. The engine being operable in a Normal Firing (NF) mode and at least one of four hybrid modes, the four hybrid modes being an Air Expander (AE) mode, an Air Compressor (AC) mode, an Air Expander and Firing (AEF) mode and a Firing and Charging (FC) mode.

The present invention further provides devices, systems, and methods as claimed.

### BRIEF DESCRIPTION OF THE DRAWINGS

The invention will be more fully understood from the following detailed description taken in conjunction with the accompanying drawings, in which:

FIG. 1 is a schematic cross-sectional view of a prior art split-cycle air hybrid engine;

FIG. 2 is a profile view of a prior art cam;

FIG. 3 is a plot of valve lift as a function of crank angle for a valve actuated by the prior art cam of FIG. 2 and for a valve actuated by a lost-motion system in conjunction with the prior art cam of FIG. 2;

FIG. 4 is a plot of valve lift as a function of crank angle for a variety of opening durations for a valve actuated by the prior art cam of FIG. 2;

FIG. 5 is a schematic view of one embodiment of a valve train and dwell cam according to the present invention;

FIG. 6 is a profile view of several embodiments of a dwell cam according to the present invention;

FIG. 7 is a plot of valve lift as a function of crank angle for a valve actuated by one embodiment of a valve train according to the present invention;

FIG. 8 is a plot of valve lift as a function of crank angle for a valve actuated by a prior art cam;

FIG. 9 is a schematic cross-sectional view of an air hybrid split-cycle engine according to the present invention;

FIG. 10A is a map showing dwell usage at various speeds and loads for the XovrC valve of one exemplary embodiment of an air hybrid split-cycle engine when the engine is operating in AC mode and the air tank is charged to 10 bar;

FIG. 10B is a map showing dwell usage at various speeds and loads for the XovrC valve of one exemplary embodiment of an air hybrid split-cycle engine when the engine is operating in AC mode and the air tank is charged to 20 bar;

FIG. 10C is a map showing dwell usage at various speeds and loads for the XovrC valve of one exemplary embodiment of an air hybrid split-cycle engine when the engine is operating in AC mode and the air tank is charged to 30 bar;

FIG. 11A is a map showing dwell usage at various speeds and loads for the XovrE valve of one exemplary embodiment of an air hybrid split-cycle engine when the engine is operating in AE mode and the air tank is charged to 10 bar;

FIG. 11B is a map showing dwell usage at various speeds and loads for the XovrE valve of one exemplary embodiment of an air hybrid split-cycle engine when the engine is operating in AE mode and the air tank is charged to 20 bar;

FIG. 11C is a map showing dwell usage at various speeds and loads for the XovrE valve of one exemplary embodiment of an air hybrid split-cycle engine when the engine is operating in AE mode and the air tank is charged to 30 bar;

FIG. 12A is a map showing dwell usage at various speeds and loads for the XovrE valve of one exemplary embodiment of an air hybrid split-cycle engine when the engine is operating in AEF mode and the air tank is charged to 10 bar;

FIG. 12B is a map showing dwell usage at various speeds and loads for the XovrE valve of one exemplary embodiment of an air hybrid split-cycle engine when the engine is operating in AEF mode and the air tank is charged to 20 bar;

FIG. 12C is a map showing dwell usage at various speeds and loads for the XovrE valve of one exemplary embodiment of an air hybrid split-cycle engine when the engine is operating in AEF mode and the air tank is charged to 30 bar;

FIG. 13A is a map showing dwell usage at various speeds and loads for the XovrC valve of one exemplary embodiment of an air hybrid split-cycle engine when the engine is operating in FC mode at a 1 g/s charging rate and the air tank is charged to 10 bar;

FIG. 13B is a map showing dwell usage at various speeds and loads for the XovrE valve of one exemplary embodiment of an air hybrid split-cycle engine when the engine is operating in FC mode at a 1 g/s charging rate and the air tank is charged to 10 bar;

FIG. 13C is a map showing dwell usage at various speeds and loads for the XovrC valve of one exemplary embodiment of an air hybrid split-cycle engine when the engine is operating in FC mode at a 1 g/s charging rate and the air tank is charged to 20 bar;

FIG. 13D is a map showing dwell usage at various speeds and loads for the XovrE valve of one exemplary embodiment of an air hybrid split-cycle engine when the engine is operating in FC mode at a 1 g/s charging rate and the air tank is charged to 20 bar;

FIG. 14A is a map showing dwell usage at various speeds and loads for the XovrC valve of one exemplary embodiment of an air hybrid split-cycle engine when the engine is operating in FC mode at a 2 g/s charging rate and the air tank is charged to 10 bar;

FIG. 14B is a map showing dwell usage at various speeds and loads for the XovrE valve of one exemplary embodiment of an air hybrid split-cycle engine when the engine is operating in FC mode at a 2 g/s charging rate and the air tank is charged to 10 bar;

FIG. 14C is a map showing dwell usage at various speeds and loads for the XovrC valve of one exemplary embodiment of an air hybrid split-cycle engine when the engine is operating in FC mode at a 2 g/s charging rate and the air tank is charged to 20 bar; and

FIG. 14D is a map showing dwell usage at various speeds and loads for the XovrE valve of one exemplary embodiment of an air hybrid split-cycle engine when the engine is operating in FC mode at a 2 g/s charging rate and the air tank is charged to 20 bar.

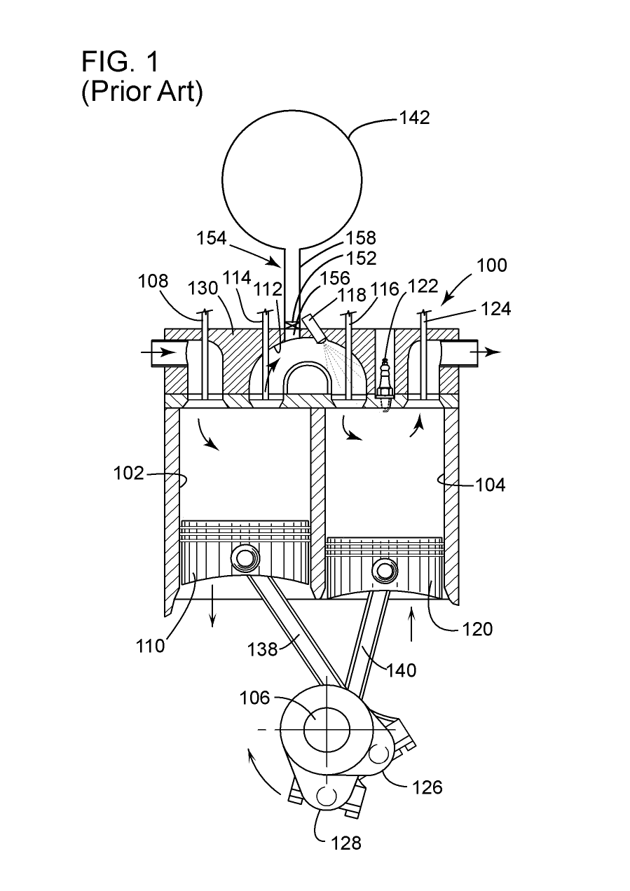

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Although certain methods and devices are disclosed herein in the context of an air hybrid split-cycle engine, a person having ordinary skill in the art will appreciate that the methods and devices disclosed herein can be used in any cam-actuated system, including, without limitation, non-hybrid engines, two-stroke and four-stroke engines, conventional engines, diesel engines, etc.

In order to operate split-cycle engines at maximum efficiency, and in particular to operate each of the various modes of an air hybrid split-cycle engine, it is desirable to vary the opening timing, closing timing, lift, and/or various other engine valve parameters.

One method of adjusting valve timing and lift, given a fixed cam profile, is to incorporate a “lost-motion” device in the valve train linkage between the valve and the cam. As noted above, lost motion is a term that is generally applied to a class of technical solutions for modifying the valve motion proscribed by a cam profile with a variable length mechanical, hydraulic, or other linkage means. The variable length element, when expanded fully, transmits all of the cam motion to the valve, and when contracted fully, transmits none or a minimum amount of the cam motion to the valve.

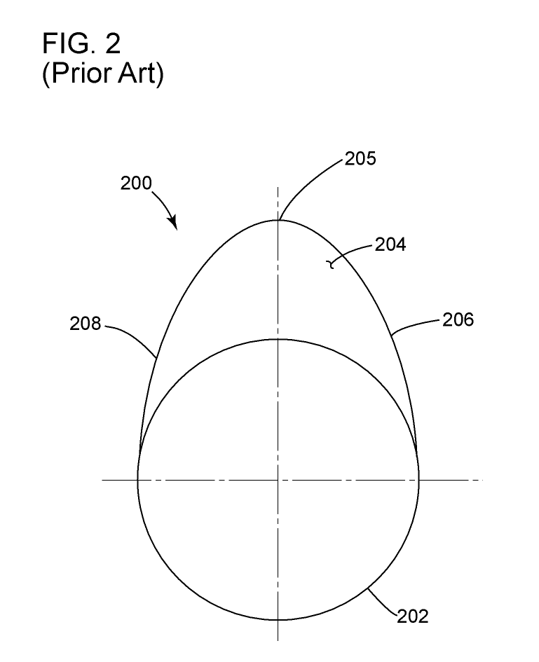

FIG. 2 illustrates a prior art cam 200 for use with a lost-motion system. The cam 200 includes a cylindrical portion, generally referred to as the base circle 202, which does not impart any linear motion to the valve. The cam 200 also includes a lift (or eccentric) portion 204 that imparts the linear motion to the valve. The contour of the cam's eccentric portion 204 controls the lift profile of the valve. The eccentric portion comprises an opening ramp 206 and a closing ramp 208. Notably, the eccentric portion 204 rises to a single peak 205 at substantially a single point on its contour, and has no dwell section (i.e., no plateau-shaped section of substantially constant radius).

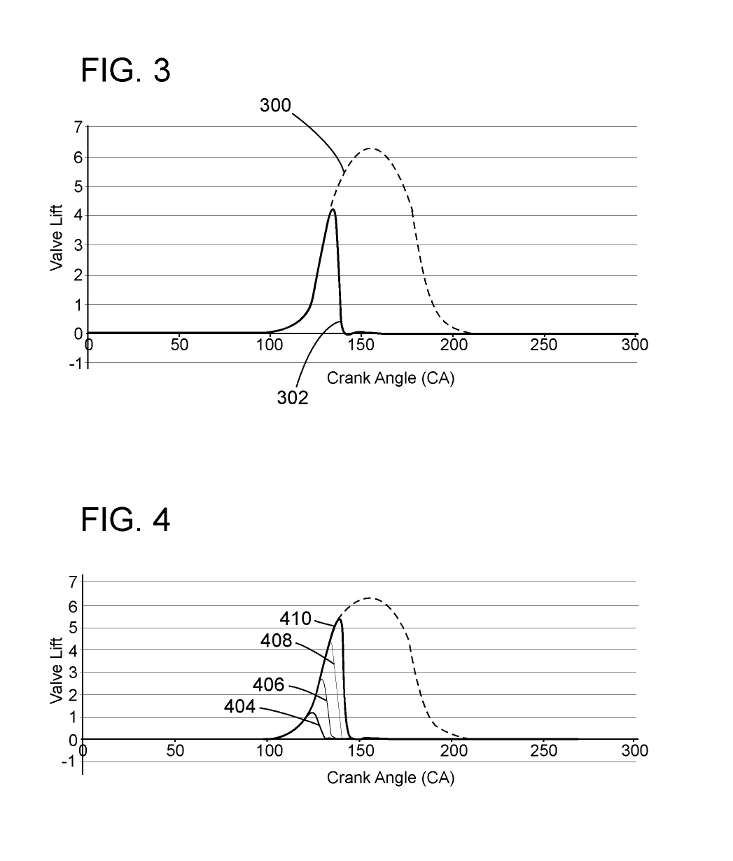

FIG. 3 illustrates a plot of valve lift as a function of time (expressed in terms of crank angle) using the cam 200 of FIG. 2. The first plot 300 depicts the valve lift when no lost-motion system is used, or when the lost-motion system is not activated. In this case, the valve opens as the opening ramp 206 imparts motion to the valve (or an element intermediate thereto), and closes as the closing ramp 208 contacts the valve (or intermediate element). The second plot 302 shows the valve lift when a lost-motion system is actuated to close the valve early. As shown, the valve opens as the opening ramp 206 contacts the valve, but closes before the closing ramp 208 contacts the valve when the lost-motion system is actuated to operatively separate the valve from the cam.

FIG. 4 shows a series of plots 404, 406, 408, 410 illustrating the valve lift for various valve opening durations when a prior art cam is used. As shown, the longer the duration, the higher the valve must be lifted. Since engine valves are typically biased to a closed position by a high rate valve spring, this additional lift results in wasted energy, robbing the engine of efficiency. In addition, this added lift undesirably reduces the maximum achievable valve actuation rates. This is particularly troublesome in split-cycle engines which ignite their charge after the expansion piston reaches its TDC position (such as the engine 100), since the dynamic actuation of the crossover valves 114, 116 is very demanding. This is because the crossover valves must generally achieve sufficient lift to fully transfer the fuel-air charge in a very short period of crankshaft rotation (typically in a range of about 30 to 60 degrees CA) relative to that of a conventional engine, which normally actuates the valves for a period of approximately 180 degrees CA. This means that the crossover valves are required to actuate about four to six times faster than the valves of a conventional engine. As a consequence of the faster actuation requirements, the crossover valves have a severely restricted maximum lift compared to that of valves in a conventional engine. Typically, the maximum lift of these crossover valves is in the order of 2-3 mm, as compared to about 10-12 mm for valves in a conventional engine. Thus, it is not possible to achieve the fast actuation rates and dynamic valve actuation required for efficient split-cycle and air hybrid split-cycle operation with the cam 200 of FIG. 2.

As used herein, a “dwell cam” refers to a cam that includes a dwell section (i.e., a section of the eccentric portion of the cam having a constant radius) of at least 5 degrees CA. For purposes herein, the dwell section is referred to as being part of the eccentric portion of the cam, even though the dwell section is concentric with the base circle portion of the cam in one or more illustrated embodiments. Dwell cams having a relatively small dwell section (e.g., 20-40 degrees CA) have been used on very large, slow engines (e.g., ship or locomotive engines that operate at less than 1000 rpm). Dwell cams have not been used, however, in medium and light duty applications or in higher-speed engines. In these engines, there is typically not enough time to achieve the requisite valve lift, hold the valve open during a dwell period, and then close the valve, all within one cycle of the engine. To do so would require impractically or even impossibly high valve accelerations. In other words, in conventional higher-speed engines (e.g., engines that operate above 1000 rpm), there is generally just enough time to open the valve to full lift and then close the valve in a given cycle. There is no time for a dwell period.

Dwell cams, however, can provide appreciable energy savings when used with split-cycle engines and in particular with air hybrid split-cycle engines. For example, in an air hybrid split-cycle engine operating in AC mode, use of a dwell cam permits the XovrC valve to be held open for an extended duration, thereby allowing more of the compression stroke charge to be transferred to the air tank in a given cycle without requiring excessive XovrC valve lift and the energy losses associated therewith. Meanwhile, a lost-motion system can be employed to allow the same engine and same cam to operate with little or no dwell when in NF mode. The extreme valve accelerations that would otherwise be required to use the dwell cam in NF mode at higher speeds (e.g., above about 1000 rpm) can thus be avoided. Dwell cams can also allow for the use of lighter components because there is only a need to support lower valve lifts. Use of dwell cams can also reduce packaging claims for the moving parts of the valve train, and eliminate the need to store excess energy in a gas valve spring. The lower spring forces associated with some dwell cams can also reduce peak contact stresses between the valve train components, which can improve packaging and actuation speed.

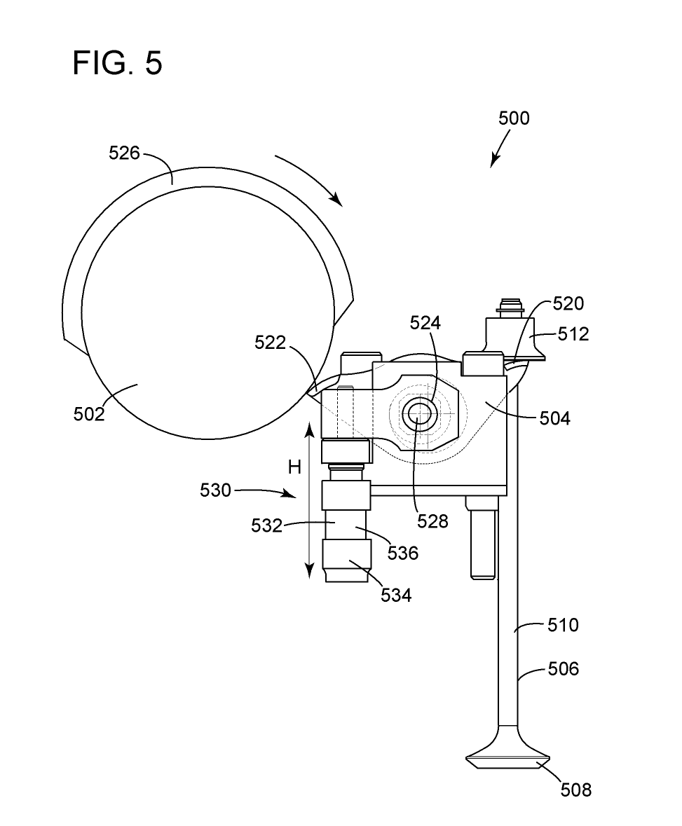

Referring now to FIG. 5, an exemplary embodiment of a valve train 500 according to the present invention for use with the engine 100 described above is illustrated. The valve train 500 can be used to actuate any of the valves of the engine 100, including, without limitation, the XovrC valve and the XovrE valve. For purposes herein, a valve train of an internal combustion engine is defined as a system of valve train elements, which are used to control the actuation of the valves. The valve train elements generally comprise a combination of actuating elements and their associated support elements. The actuating elements (e.g., cams, tappets, springs, rocker arms, valves and the like) impart the actuation motion to the valves (i.e., to open and close the valves) of the engine during each valve opening event. The support elements (e.g., shafts, pedestals or the like) securely mount and guide the actuating elements.

As shown, the valve train 500 includes a cam 502, a rocker 504, and a valve 506. The valve train 500 also includes one or more associated support elements, which for purposes of brevity are not illustrated in FIG. 5. The valve 506 includes a valve head 508 and a valve stem 510 extending vertically from the valve head 508. A collet (not shown) secures a valve adapter assembly 512 to the tip of the stem 510 opposite the head 508. A valve spring (not shown) holds the valve head 508 securely against a valve seat (not shown) when the valve 506 is in its closed position. Any of a variety of valve springs can be used for this purpose, including, for example, air or gas springs. In addition, although the illustrated valve is an outwardly-opening poppet valve, any cam actuated valve can be used, including inwardly-opening poppet valves, without departing from the scope of the present invention.

The rocker 504 includes a forked rocker pad 520 at one end, which straddles the valve stem 510 and engages the underside of the valve adapter assembly 512. Additionally, the rocker 504 includes a solid rocker pad 522 at an opposing end, which slidably contacts the cam 502 of the valve train 500. The rocker 504 also includes a rocker shaft bore 524 extending therethrough.

The forked rocker pad 520 of the rocker 504 contacts the valve adapter assembly 512 of the outwardly-opening poppet valve 506 such that a downward direction of the rocker pad 522 caused by the actuation of the cam 502 translates into an upward movement of the rocker pad 520, which in turn opens the valve 506.

The cam 502 is a dwell cam, since it includes a dwell section of at least 5 degrees CA. In the illustrated embodiment, the dwell cam 502 rotates in the direction of the illustrated arrow. As an eccentric portion 526 of the cam 502 contacts the rocker pad 522, the rocker 504 rotates about a rocker shaft 528 disposed within the rocker shaft bore 524 to lift the valve 506 off of its seat.

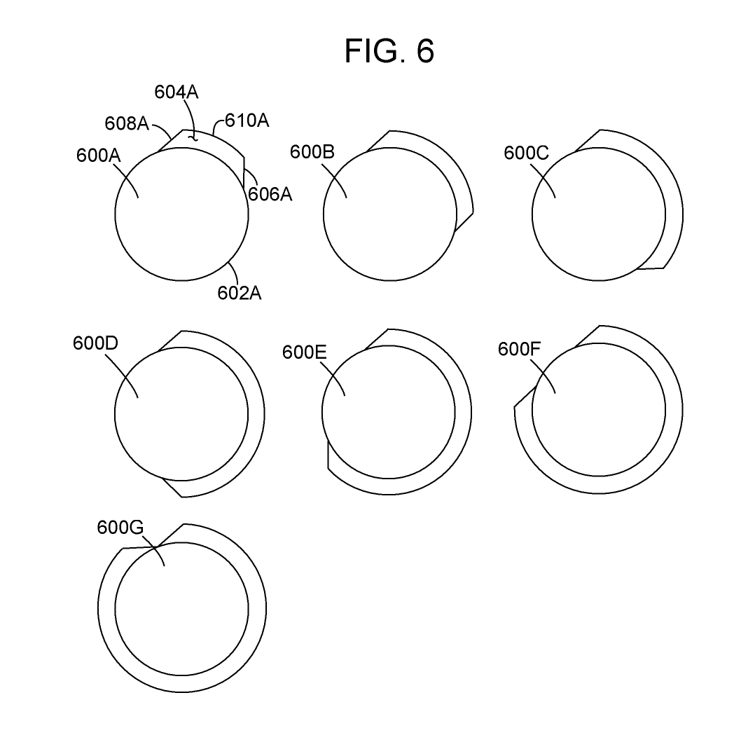

FIG. 6 illustrates a plurality of dwell cams 600A-600G according to embodiments of the present invention. Each of the cams 600A-600G generally includes a base circle portion and an eccentric portion. The eccentric portion comprises an opening ramp, a closing ramp, and a dwell section. For example, the cam 600A includes a base circle portion 602A and an eccentric portion 604A having an opening ramp 606A, a closing ramp 608A, and a dwell section 610A. The dwell section can be of various sizes, (i.e., at least 5 degrees CA) and is sized to match the longest possible valve opening duration needed over a full range of engine operating conditions and air hybrid modes. The opening ramp of the valve is set to any value that adequately achieves the maximum lift required of the engine valve at the desired rate. The closing ramp (or “landing” ramp) is shaped to rapidly decelerate the velocity of the valves as they approach their valve seats. In the illustrated embodiments, the dwell sections of the cams 600A-600G are as follows:
600A-45 degrees cam angle
600B-90 degrees cam angle
600B-135 degrees cam angle
600D-180 degrees cam angle
600E-225 degrees cam angle
600F-270 degrees cam angle
600G-315 degrees cam angle

It will be appreciated that the length of the dwell section in terms of crank angle CA will depend upon the ratio of crankshaft revolutions to revolutions of the cam. In embodiments in which the crankshaft rotates twice for each cam revolution, the length of the illustrated dwell sections in terms of crank angle CA are as follows:
600A-90 degrees CA
600B-180 degrees CA
600B-270 degrees CA
600D-360 degrees CA
600E-450 degrees CA
600F-540 degrees CA
600G-630 degrees CA

The illustrated dwell cams are merely exemplary embodiments. The dwell cam can have a variety of dwell section lengths, including, for example, at least about 5 degrees, between about 5 degrees CA and about 100 degrees CA, and between about 5 degrees CA and about 200 degrees CA.

The valve train 500 also includes a lost-motion system 530 to subtract or lose part or all of the motion imparted by the cam to the valve. The lost-motion system 530 comprises a collapsible element 532 that supports the rocker shaft 528 about which the rocker 504 pivots or rotates. The collapsible 532 element includes first and second cylindrical telescoping halves 534, 536 defining a fluid chamber between the respective interiors thereof. When the collapsible element 532 is actuated, fluid is displaced from the fluid chamber into a hydraulic accumulator (not shown) allowing the first and second telescoping halves 534, 536 to slide relative to and towards each other, thereby reducing the overall height H of the collapsible element. The collapsible element 532 is actuated by a solenoid valve and a check valve in communication with the hydraulic circuit including the fluid chamber and accumulator. The solenoid valve can be maintained in a closed position in order to retain hydraulic fluid in the circuit. As long as the solenoid valve remains closed, the rocker 504 is supported and motion imparted thereto by the cam 502 is transferred to the valve 506, lifting it off of its seat.

When the solenoid is opened temporarily, the circuit partially or completely drains, allowing the collapsible element 532 to partially or fully collapse, thereby lowering the pivot point of the rocker arm 504. In this situation, insufficient cam motion is imparted to rocker arm 504 to actually lift the valve 506 off of its seat, and thus the valve 506 closes or remains closed. The collapsible element 532 can thus provide a lost-motion feature that allows for variable valve actuation (i.e., permits the valve 506 to close at an earlier time than that provided by the cam 502 profile). It will be appreciated that by varying the degree to which fluid is drained from the lost-motion system 530, the degree to which the valve is allowed to open or close can also be varied, thus permitting for variable valve lift.

The collapsible element 532 also advantageously takes up any lash that may exist in the valve train 500, for example, due to thermal expansion and contraction, component wear, etc. For purposes herein, the terms “valve lash” or “lash” are defined as the total clearance existing within the valve train 500 when the valve 506 is fully seated. The valve lash is equal to the total contribution of all the individual clearances between all individual valve train elements (i.e., actuating elements and support elements) of the valve train.

Although the illustrated embodiment includes a hydraulic collapsible element 532 to provide lost-motion functionality, virtually any lost-motion system can be employed without departing from the scope of the present invention. One skilled in the art would recognize that other lost-motion systems may be used (e.g., pneumatic, mechanical, electrical, electromagnetic, and/or combinations thereof). Other examples of lost-motion systems are described at length in U.S. application Ser. No. 13/359,521, entitled “LOST-MOTION VARIABLE VALVE ACTUATION SYSTEM WITH CAM PHASER” filed on an even date herewith, which is hereby incorporated by reference in its entirety.

In cam-driven actuation systems, the closing or landing ramp of the cam generally dictates the speed at which the valve contacts its seat when the valve closes. If the valve is closed early, however (i.e., by actuating a lost-motion system before the closing ramp reaches the rocker), the valve undesirably “free-falls” under the stiffness of the valve spring. This causes the valve to crash against the valve seat, damaging the valve, the seat, and/or other components of the valve train. Accordingly, although not shown, a valve seating control device or “valve catch” is included in the valve train 500 to rapidly decelerate the velocity of the valve 506 as it approaches the valve seat when closing. For example, a hydraulic valve catch can be operatively coupled to the valve 506.

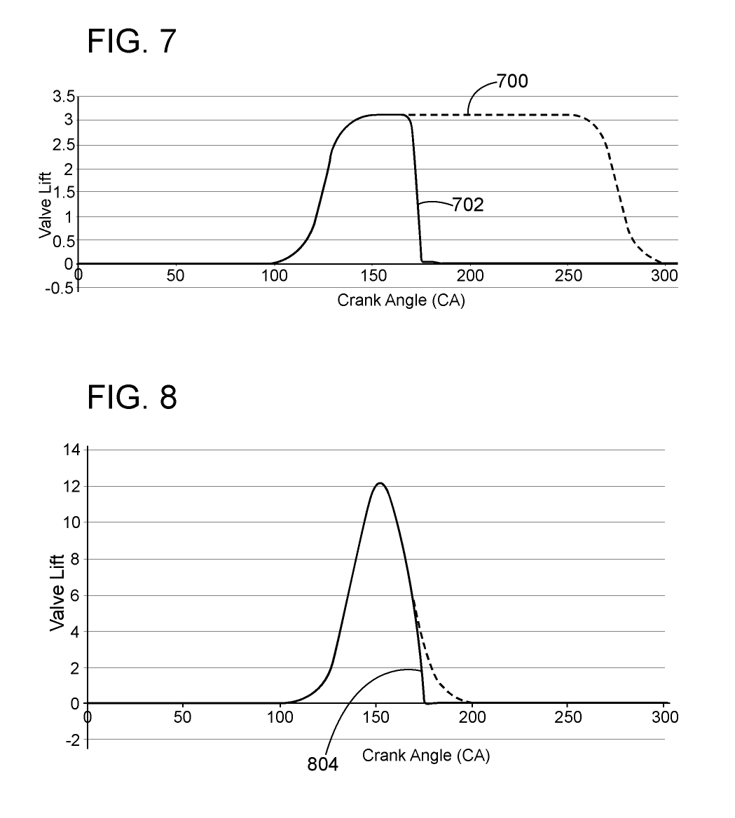

FIG. 7 illustrates two plots 700, 702 of valve lift as a function of crank angle for a valve train including a dwell cam in accordance with the present invention. The first plot 700 illustrates the valve lift when the lost-motion system is not used (e.g., when the solenoid valve is closed such that the fluid chamber of the collapsible element remains filled with incompressible hydraulic fluid and all of the cam's motion is imparted to the valve). As shown, the dwell section of the cam results in a sustained, substantially constant valve lift over the entire dwell section. The second plot 702 shows the valve lift when the lost-motion system is actuated to vary the time, or position, at which the valve closes (i.e., to close the valve early). It will be appreciated from FIG. 7 that, with the use of a dwell cam, the maximum valve lift remains generally constant regardless of how early or late the valve is closed (assuming the valve is closed at some point during the dwell section of the cam and not on the opening or closing ramp).

FIG. 8, on the other hand, illustrates a plot 804 of valve lift as a function of crank angle for a valve train that includes a prior art cam 200. As shown, to achieve the same opening duration as in the plot 702 of FIG. 7, while also maintaining approximately the same opening ramp rate, the valve must be lifted substantially higher off of the valve seat. As explained above, this additional lift slows valve actuation, reduces engine efficiency, and leads to a variety of design constraints. Moreover, the energy required to lift a valve using prior art cams like the one shown in FIG. 2 is typically upwards of 3 joules per lift. In one embodiment of the present invention, on the other hand, the energy required to lift the crossover valve is less than about 1.5 joules, and preferably less than about 1.0 joules, and even more preferably less than about 0.5 joules.

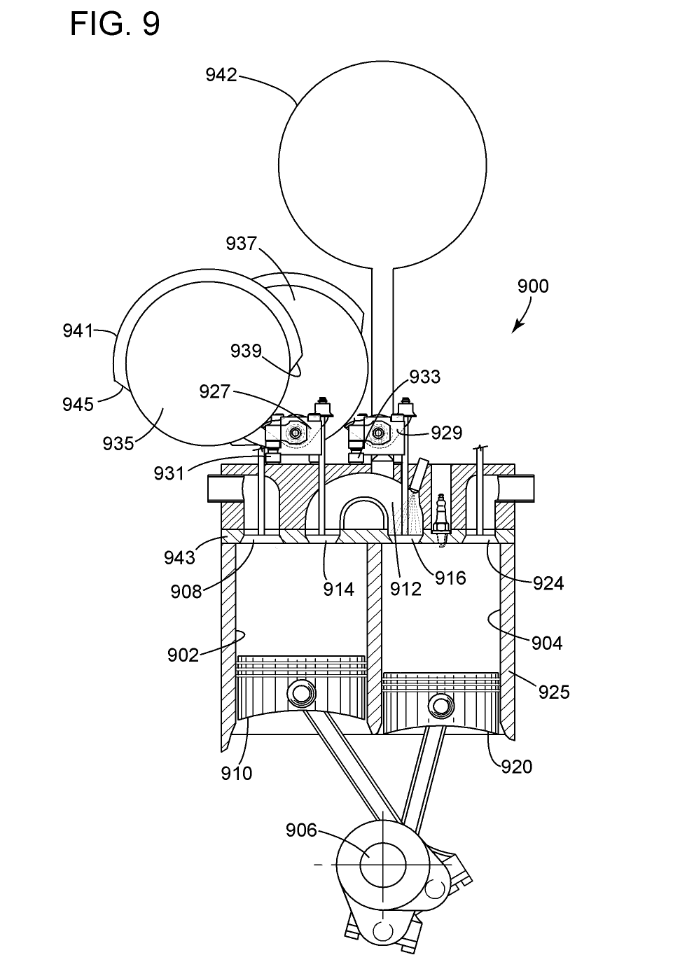

FIG. 9 illustrates one embodiment of an air hybrid split-cycle engine according to the invention. As shown, the engine 900 has a compression cylinder 902 and an expansion cylinder 904 in which a compression piston 910 and an expansion piston 920 respectively reciprocate. The pistons 910, 920 are coupled to a crankshaft 906 rotatably journaled into an engine block 925. The compression cylinder 902 and the expansion cylinder 904 are joined by at least one crossover passage 912. The inlet of the crossover passage 912 is selectively opened and closed via an outwardly-opening cam-actuated “XovrC” poppet valve 914. The outlet of the crossover passage 912 is selectively opened and closed via an outwardly-opening cam-actuated “XovrE” poppet valve 916. The stems of the crossover valves 914, 916 are engaged by respective rockers 927, 929, which are in turn pivotally mounted on rocker shafts supported by collapsible lost-motion systems 931, 933. The rockers 927, 929 are engaged at a second end opposite the valve-engaging end by respective dwell cams 935, 937 mounted to respective camshafts.

During operation, the crankshaft 906 rotates causing the pistons 910, 920 to reciprocate in the respective cylinders 902, 904. As the crankshaft 906 rotates, the dwell cams 935, 937 also rotate as a result of their linkage to the crankshaft via a timing belt, chain, gear, or similar mechanism (not shown). As the dwell cam 935 rotates, an opening ramp portion 939 thereof contacts the rocker 927 and imparts motion thereto (e.g., by causing the rocker 927 to pivot or rotate counterclockwise). This in turn causes the valve-engaging end of the rocker 927 to impart motion to the valve 914 (e.g., by lifting the valve 914 upwards from its valve seat) and thereby opens the valve 914. When a dwell portion 941 of the cam 935 contacts the rocker 927, the rocker 927 is held in a substantially fixed angular orientation which in turn holds the valve 914 open at a substantially fixed linear distance from the valve seat. If valve closing control is called for, pressurized hydraulic fluid maintained in the collapsible lost-motion system 931 is rapidly drained, reducing the vertical height of the rocker shaft with respect to the cylinder head 943. As a result, the rocker 927 pivots or rotates clockwise under the bias of a valve spring (not shown) until the valve 914 closes against the seat. The cam-engaging end of the rocker 927 remains substantially in contact with the cam 935 throughout the actuation of the valve 914. A valve catch system can be included as explained above to control the velocity at which the valve 914 contacts the valve seat.

Alternatively, if valve closing control is not called for, the valve 914 remains open a fixed linear distance until the dwell section 941 of the cam 935 passes the rocker 927 and the rocker 927 contacts the closing ramp 945. At that time, the bias of the valve spring forcing the valve 914 closed causes the rocker 927 to pivot or rotate clockwise until the valve 914 is closed. The valve closing velocity is controlled by the closing ramp profile of the cam or by a valve catch system, as explained above. A detailed explanation of the operation of the XovrE valve 916 is omitted, as the operation thereof is substantially identical to the operation of the XovrC valve 914 in the illustrated embodiment. It will be appreciated, however, that the eccentric portions of the cams 935, 937 for the respective crossover valves 914, 916 can be aligned out of phase with each other to achieve the requisite relative valve timing.

In the illustrated embodiment, the XovrC cam 935 is a dwell cam having a dwell section of approximately 90 degrees CA. Similarly, the XovrE cam 937 is a dwell cam having a dwell section of approximately 90 degrees CA. It will be appreciated that the illustrated valve train can advantageously provide the dynamic valve actuation characteristics required for efficient operation of the air hybrid engine 900 without requiring unnecessary valve lift, as explained in detail above.

The valve trains and engines disclosed herein are configured to operate reliably over a broad range of engine speeds. In certain embodiments, engines according to the present invention are capable of operating at a speed of at least about 1000 rpm, and preferably at least about 2000 rpm, and more preferably at least about 4000 rpm, and more preferably at least about 5000 rpm, and more preferably at least about 7000 rpm.

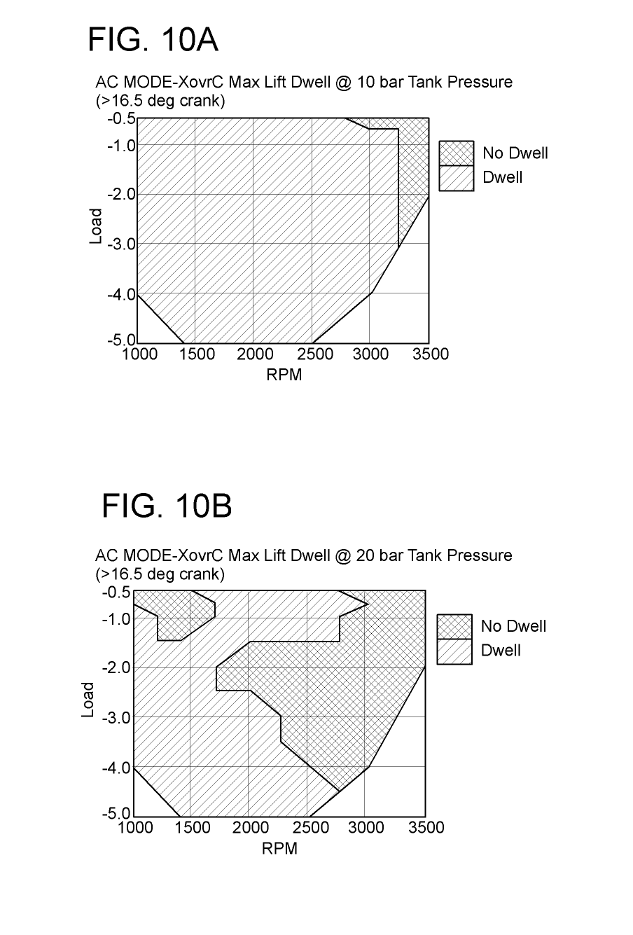

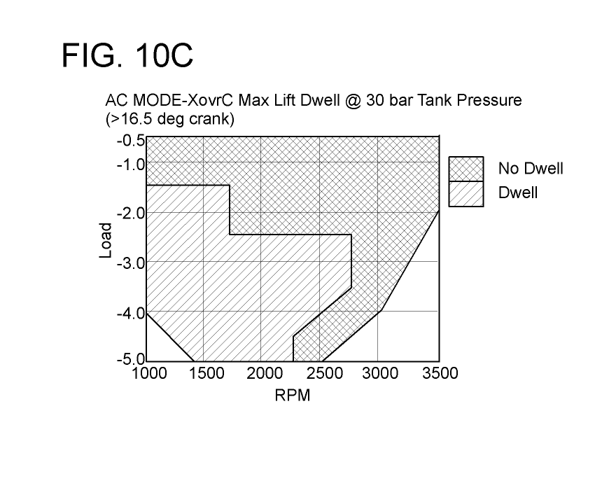

FIGS. 10A-14D illustrate maps showing dwell usage at various speeds and loads for various valves and various operating conditions of one exemplary embodiment of an air hybrid split-cycle engine of the present invention. In the illustrated maps, speed/load points where it is desirable to hold the valve open for more than 16.5 degrees CA are marked as “dwell.” Points where it is desirable to hold the valve open for 16.5 degrees CA or less are marked as “no dwell.” While 16.5 degrees CA is used as the threshold between “dwell” and “no dwell” in the illustrated embodiment, any of a variety of other duration thresholds can be used without departing from the scope of the present invention provided the valve is held in its peak lift position for at least 5 degrees CA.

FIGS. 10A-10C illustrate dwell usage for an XovrC valve of the engine when the engine is operating in AC mode and the air tank is charged to 10 bar, 20 bar, and 30 bar, respectively. Dwelling the XovrC valve in AC mode permits more of the compression stroke charge to be transferred into the air tank for storage. As shown, dwell is used considerably for the XovrC valve in the AC mode, especially when tank pressure is low. As the tank pressure increases, the need to dwell the XovrC valve is reduced, but there are still many points on the map where dwelling is advantageous. In particular, dwelling is used more frequently at low-load and/or low-speed operation. In one embodiment, dwell occurs for the XovrC valve in AC mode for approximately 68% of the conditions mapped in FIGS. 10A-10C.

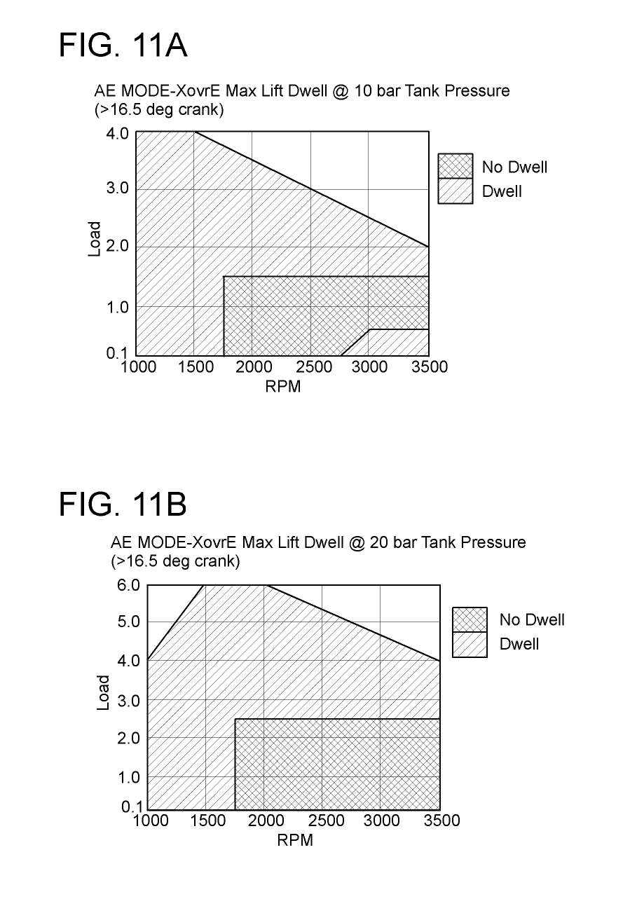

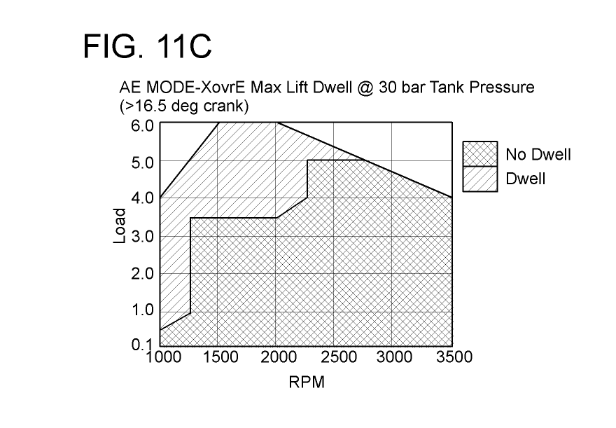

FIGS. 11A-11C illustrate dwell usage for an XovrE valve of the engine when the engine is operating in AE mode and the air tank is charged to 10 bar, 20 bar, and 30 bar, respectively. Dwelling the XovrE valve in AE mode permits more of the charge stored in the air tank to be transferred into the expansion cylinder. As shown, dwell is used considerably for the XovrE valve in the AE mode, especially when tank pressure is low. As the tank pressure increases, the need to dwell the XovrE valve is reduced, but there are still many points on the map where dwelling is advantageous. In particular, dwelling is used more frequently at high-load and/or low-speed operation. In one embodiment, dwell occurs for the XovrE valve in AE mode for approximately 56% of the conditions mapped in FIGS. 11A-11C.

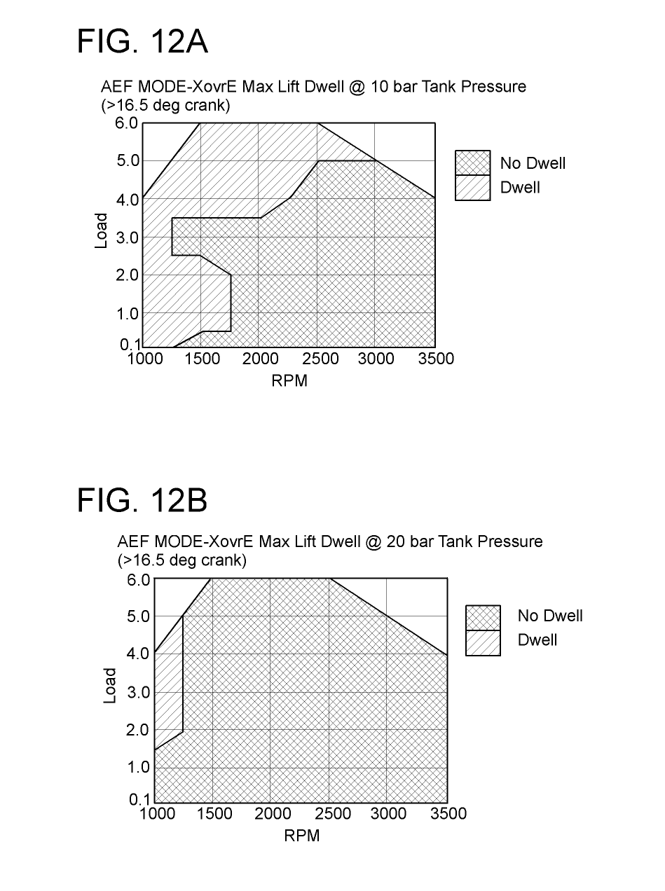

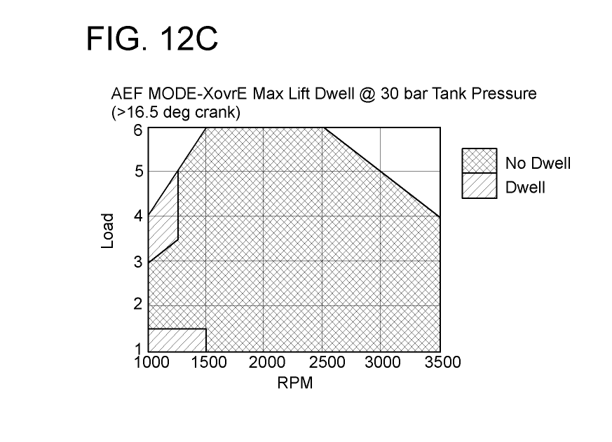

FIGS. 12A-12C illustrate dwell usage for an XovrE valve of the engine when the engine is operating in AEF mode and the air tank is charged to 10 bar, 20 bar, and 30 bar, respectively. Dwelling the XovrE valve in AEF mode permits more of the charge stored in the air tank to be transferred into the expansion cylinder. As shown, dwell is used less often for the XovrE valve in AEF mode than in AE mode, but is still used when tank pressure is low and in some low-speed/high-load and low-speed/low-load conditions for higher tank pressures. In one embodiment, dwell occurs for the XovrE valve in AEF mode for approximately 16% of the conditions mapped in FIGS. 12A-12C.

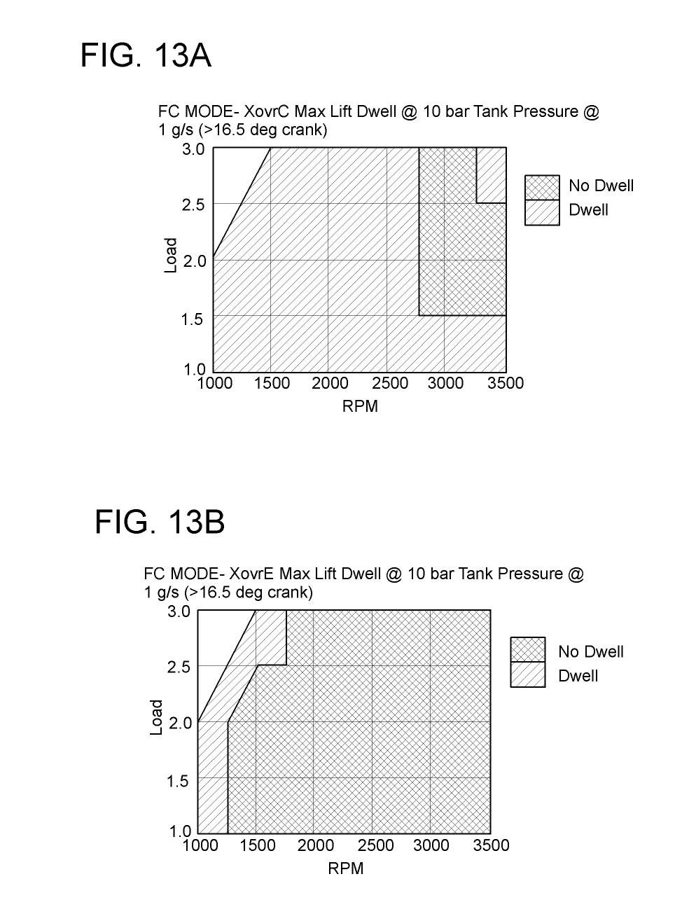

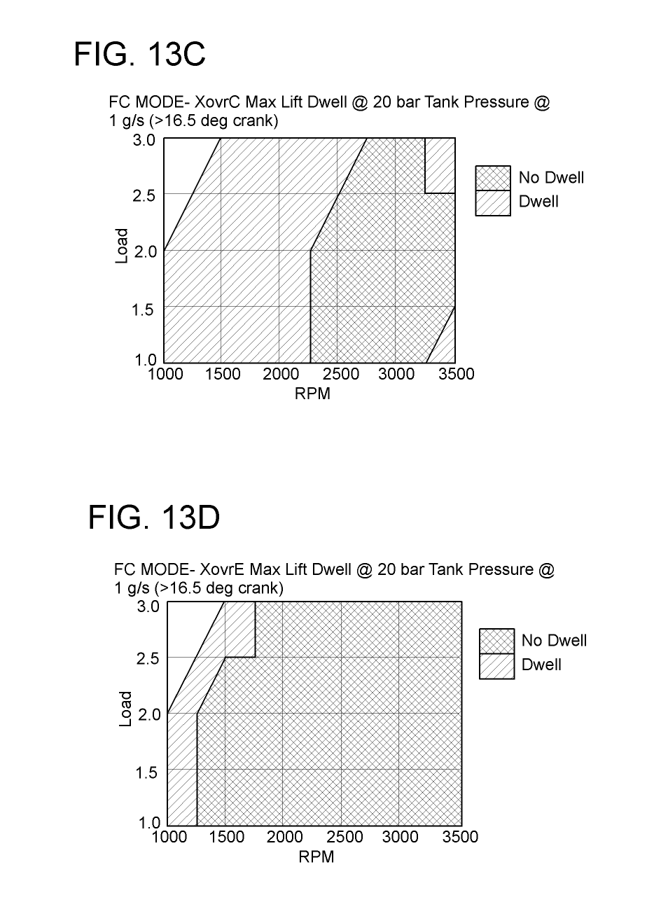

FIGS. 13A and 13C illustrate dwell usage for an XovrC valve of the engine when the engine is operating in FC mode and the air tank is charged to 10 bar and 20 bar, respectively. Dwelling the XovrC valve in FC mode permits more of the compression charge to be transferred to the air tank. FIGS. 13B and 13D illustrate dwell usage for an XovrE valve of the engine when the engine is operating in FC mode and the air tank is charged to 10 bar and 20 bar, respectively. Dwelling the XovrE valve in FC mode permits more of the charge stored in the air tank to be transferred into the expansion cylinder. As shown, dwell is used considerably for the XovrC valve in the FC mode, especially when tank pressure is low. As the tank pressure increases, the need to dwell the XovrC valve is reduced, but there are still many points on the map where dwelling is advantageous. As shown in FIGS. 13B and 13D, dwell is used to a lesser extent on the XovrE valve in the FC mode, however it is still used for many low-speed operating conditions.

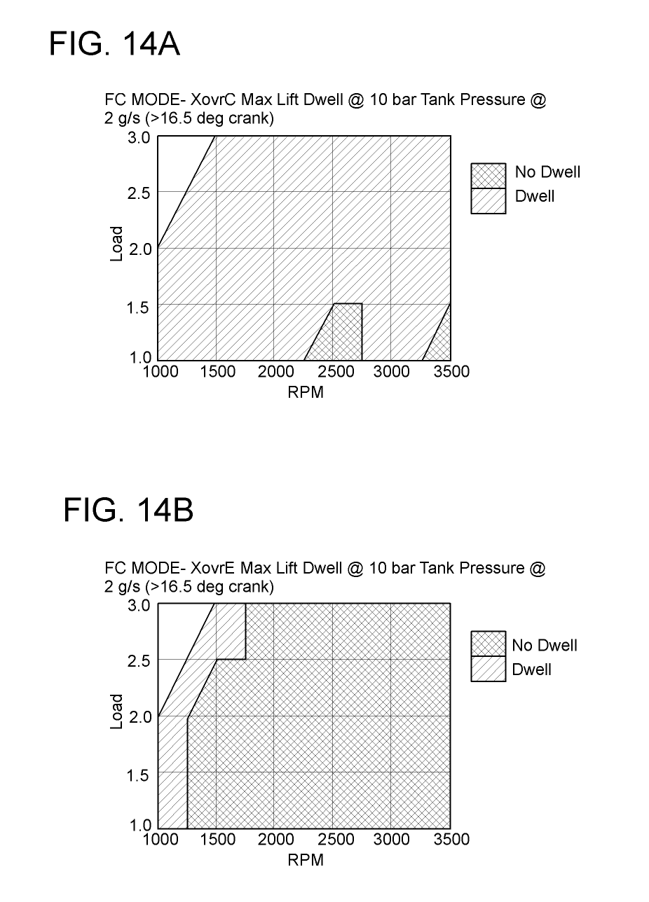

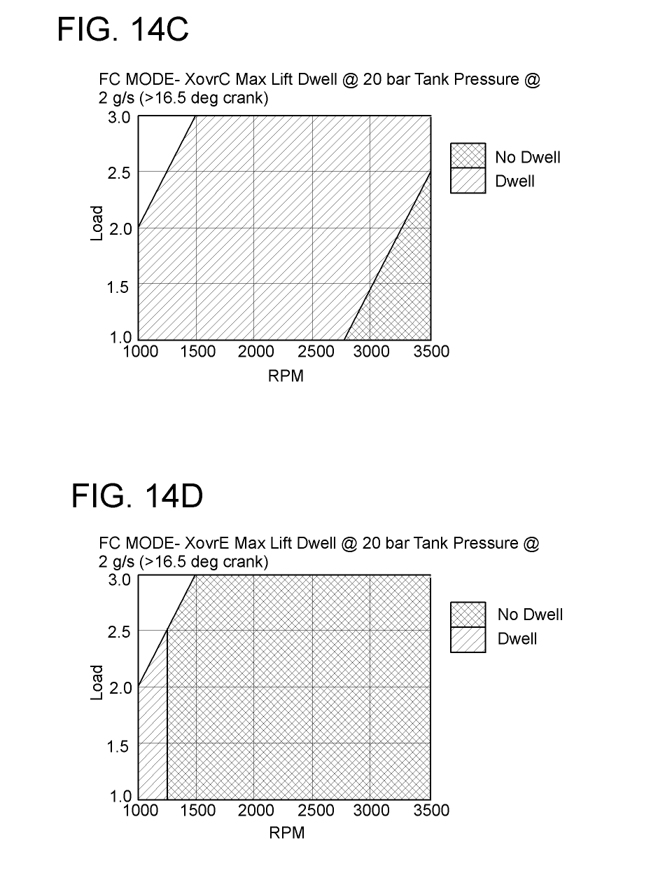

FIGS. 13A-13D illustrate FC mode dwell usage when a 1 g/s tank charging rate is used. FIGS. 14A-14D, on the other hand, illustrate FC mode dwell usage when the tank charging rate is doubled to 2 g/s. Thus, in FIGS. 14A-14D, the ratio of compression charge stored in the air tank to compression charge transferred to the expansion cylinder is greater than in FIGS. 13A-13D. As shown in FIGS. 14A and 14C, dwell is used considerably for the XovrC valve under these operating conditions, especially when tank pressure is low. Meanwhile, as shown in FIGS. 14B and 14D, dwell is used to a lesser extent on the XovrE valve in the FC mode, however it is still used for many low-speed operating conditions. In one embodiment, dwell occurs for the XovrC valve in FC mode for approximately 73% of the conditions mapped in FIGS. 13A-14D, while dwell occurs for the XovrE valve in FC mode for approximately 21% of the conditions mapped in FIGS. 13A-14D.

Although the invention has been described by reference to specific embodiments, it should be understood that numerous changes may be made within the spirit and scope of the inventive concepts described. For example, in the embodiment illustrated in FIG. 9, both crossover valves are outwardly-opening poppet valves and are actuated by a dwell cam and lost-motion system. Such is not always the case, however. For example, one or both of the crossover valves can be actuated by a cam having no dwell section or can be actuated using a cam-less system. Also, one or both of the crossover valves can be inwardly-opening. There can also be more than two crossover valves, and more than one crossover passage. The intake and exhaust valves, and any other valve in the engine for that matter, can also be actuated by a dwell cam and lost-motion system as described herein with respect to the crossover valves. The cams can be mounted to separate camshafts or can be mounted to the same camshaft. The engines disclosed herein are not limited to having only two cylinders. Accordingly, it is intended that the invention not be limited to the described embodiments, but that it have the full scope defined by the language of the following claims.

What is claimed is:

1. An engine comprising:
an air reservoir for storing compressed air during a plurality of cycles of the engine; and
at least one cam having a dwell section of at least approximately 5 degrees CA.

2. The engine of claim 1, wherein the engine is a split-cycle engine.

3. The engine of claim 1, wherein the cam actuates at least one outwardly-opening valve.

4. The engine of claim 3, wherein the at least one valve is a crossover valve in a split-cycle engine.

5. The engine of claim 1, wherein the dwell section is between about 5 degrees CA and about 720 degrees CA.

6. The engine of claim 1, wherein the dwell section is between about 10 degrees CA and about 360 degrees CA.

7. The engine of claim 1, wherein the dwell section is between about 90 degrees CA and about 180 degrees CA.

8. The engine of claim 1, wherein the engine is capable of operating at speeds in excess of 1000 rpm.

9. The engine of claim 1, further comprising a lost-motion system that permits the cam to be selectively operatively disconnected from a valve to close the valve earlier than what is called for by the cam.

10. The engine of claim 9, wherein the lost-motion system allows the valve to dwell over at least 50% of a particular speed/load map.

11. The engine of claim 9, wherein the lost-motion system allows the valve to dwell over a greater percentage of a particular speed/load map when the pressure within the air reservoir is low than when the pressure within the air reservoir is high.

12. The engine of claim 9, wherein the lost-motion system allows the valve to dwell for a longer crank angle duration when an operating speed of the engine is high than when the operating speed of the engine is low.

13. An engine, comprising:
an air reservoir configured to selectively store air from a cylinder in which said air was compressed in a compression stroke of the engine and to selectively supply air to a cylinder during an expansion stroke of the engine;
at least one engine valve configured to open and close a passageway disposed within the engine; and
a camshaft having at least one cam formed thereon, the at least one cam having a dwell section of at least 5 degrees CA and being configured to impart motion to the at least one engine valve.

14. The engine of claim 13, further comprising a lost-motion element operatively coupled to the at least one engine valve.

15. The engine of claim 13, wherein the compression stroke and the expansion stroke take place in separate cylinders of the engine.

16. The engine of claim 13, wherein the engine is a split-cycle engine.

17. The engine of claim 13, wherein the at least one valve is an outwardly-opening valve.

18. An air hybrid engine, comprising:
a cam having a base circle portion, an opening ramp portion, a closing ramp portion, and a dwell section extending between the opening ramp portion and the closing ramp portion;
wherein the dwell section extends across at least 5 degrees of the cam's profile.

19. The engine of claim 18, wherein the engine is a split-cycle engine.

20. An air hybrid engine, comprising:
a camshaft having at least one cam lobe;
wherein the cam lobe has a dwell section of at least 5 degrees CA.

21. An engine comprising:
a crankshaft rotatable about a crankshaft axis;
a compression piston slidably received within a compression cylinder and operatively connected to the crankshaft such that the compression piston reciprocates through an intake stroke and a compression stroke during a single rotation of the crankshaft;
an expansion piston slidably received within an expansion cylinder and operatively connected to the crankshaft such that the expansion piston reciprocates through an expansion stroke and an exhaust stroke during a single rotation of the crankshaft;
a crossover passage interconnecting the compression and expansion cylinders, the crossover passage including a crossover compression valve and a crossover expansion valve defining a pressure chamber therebetween;
a first cam configured to impart motion to the crossover expansion valve, the first cam having a dwell section of at least 5 degrees CA; and
a first collapsible lost-motion element having a first position in which the crossover compression valve is operatively disconnected from the first cam and a second position in which the crossover compression valve is operatively connected to the first cam.

22. The engine of claim 21, further comprising:
a second cam configured to impart motion to the crossover compression valve, the second cam having a dwell section of at least 5 degrees CA; and
a second collapsible lost-motion element having a first position in which the crossover expansion valve is operatively disconnected from the second cam and a second position in which the crossover expansion valve is operatively connected to the second cam.

23. The engine of claim 21, further comprising an air reservoir in fluid communication with the crossover passage.

24. The engine of claim 23, wherein a port at which the air reservoir communicates with the crossover passage can be selectively opened and closed using one or more valves.

25. A method of actuating an engine valve in an engine, comprising:
holding the engine valve open in a dwell position over at least 5 degrees of crankshaft rotation.

26. The method of claim 25, wherein the engine valve is held in the dwell position over at least 50% of a particular speed/load map.

27. The method of claim 25, wherein the engine valve is held in the dwell position over a greater percentage of a particular speed/load map when the pressure within an air reservoir of the engine is low than when the pressure within the air reservoir is high.

28. The method of claim 25, wherein the engine valve is held in the dwell position for a longer crank angle duration when an operating speed of the engine is high than when the operating speed of the engine is low.

29. A method of actuating an engine valve, comprising:
opening the engine valve by imparting motion thereto with an opening ramp profile of a cam having a dwell section of at least 5 degrees CA;
holding the engine valve in a fully opened position for a first time period; and
closing the engine valve by actuating a lost-motion system to operatively disconnect the engine valve from the cam.

30. A split-cycle air-hybrid engine comprising:
a crankshaft rotatable about a crankshaft axis;
a compression piston slidably received within a compression cylinder and operatively connected to the crankshaft such that the compression piston reciprocates through an intake stroke and a compression stroke during a single rotation of the crankshaft;
an expansion piston slidably received within an expansion cylinder and operatively connected to the crankshaft such that the expansion piston reciprocates through an expansion stroke and an exhaust stroke during a single rotation of the crankshaft;
a crossover passage interconnecting the compression and expansion cylinders, the crossover passage including a crossover compression (XovrC) valve and a crossover expansion (XovrE) valve defining a pressure chamber therebetween;
an air reservoir operatively connected to the crossover passage and selectively operable to store compressed air from the compression cylinder and to deliver compressed air to the expansion cylinder; and
a first cam configured to impart motion to at least one of the XovrC valve and the XovrE valve, the first cam having a dwell section of at least 5 degrees CA;
the engine being operable in a Normal Firing (NF) mode and at least one of four hybrid modes, the four hybrid modes being an Air Expander (AE) mode, an Air Compressor (AC) mode, an Air Expander and Firing (AEF) mode and a Firing and Charging (FC) mode.

31. The split-cycle air-hybrid engine of claim 30, wherein:
the first cam is configured to impart motion to the XovrC valve; and
the engine is operable in the AC mode.

32. The split-cycle air-hybrid engine of claim 30, wherein:
the first cam is configured to impart motion to the XovrE valve; and
the engine is operable in at least one of the AE mode and the AEF mode.

33. The split-cycle air-hybrid engine of claim 30, wherein:
the first cam is configured to impart motion to the XovrC valve;
the engine further comprises a second cam configured to impart motion to the XovrE valve, the second cam having a dwell section of at least 5 degrees CA; and
the engine is operable in the FC mode.

34. The split-cycle air-hybrid engine of claim 33, wherein the engine is operable in the AC mode, the AE mode, and the AEF mode.
